(19) United States
(12) Patent Application Publication
(10) Pub. No.: US 2005/0070649 A1
(43) Pub. Date: Mar. 31, 2005

(54) Low VOC primer for roofing and waterproofing membranes

(76) Inventor: Dennis K. Fisher, Brooklyn, MI (US)

Correspondence Address: DINSMORE & SHOHL LLP;Suite 500, One Dayton Centre, Dayton, OH, 45402-2023, US

(21) Appl. No.: 10/672,089

(22) Filed: Sep. 26, 2003

(51) Int. Cl. C08K 5/09

(52) U.S. Cl. 524/270; 524/306

(57) ABSTRACT

A primer composition is provided for priming roofing and waterproofing membranes such as EPDM and TPO. The primer composition includes a halogenated copolymer of isobutylene and p-methyl styrene, a thermoplastic rubber, a tackifier, and a solvent comprising water and at least one volatile organic compound. The primer composition also preferably includes a plasticizer and an accelerator/cure package. The primer composition exhibits a volatile organic compound (VOC) content of less than about 250 g/l, and promotes effective adhesion of roofing adhesives to roofing membranes.

### BACKGROUND OF THE INVENTION

This invention relates to a low VOC primer composition for priming EPDM and TPO roofing and waterproofing membranes, and more particularly, to a low VOC primer composition which effectively primes roofing membranes to enhance the adhesion of roofing adhesives used on such membranes.

Membrane roofing materials used to cover large roof areas are typically prepared in the form of flat sheets of single-ply or multiple-ply sheets formed of polymeric materials such as EPDM (ethylene propylene diene monomer) or TPO (thermoplastic polyolefin). In the field of single-ply commercial rubber roofing, sheets of roofing material are typically laid on a roof in an overlapping fashion and spliced together to form a continuous sheet which covers the roof. Lap joints are typically used to splice adjacent sheets of roofing material together. The exposed seams of the lap joints are then sealed with an adhesive, typically, a caulking compound, to act as an additional seal to prevent penetration of moisture along the external seam.

It is generally desirable to use a primer on the membrane substrate prior to applying the adhesive in order to enhance the strength and durability of the final bond between the adhesive and substrate. However, conventional commercial primers often comprise from 80 to 95% by weight organic solvent. The use of such high VOC (volatile organic compound) compositions is being regulated in many areas due to environmental or health concerns.

Accordingly, there is still a need in the art for a primer composition for use on EPDM and TPO roofing membrane materials which promotes effective adhesion of roofing adhesives to such membranes without containing an excessive concentration of volatile organic compounds.

### SUMMARY OF THE INVENTION

The present invention meets those needs by providing a primer composition having a low VOC content of less than 250 g/l which effectively primes the surfaces of roofing or waterproofing membranes such as EPDM or TPO to promote the adhesion of roofing adhesives to such membranes.

In accordance with one aspect of the present invention, a primer composition for use on roofing materials is provided comprising a halogenated copolymer of isobutylene and p-methyl styrene, a thermoplastic rubber, a tackifier, and a solvent comprising water and at least one volatile organic compound, where the composition has at least one volatile organic compound (VOC) content of less than about 250 g/l.

The primer composition preferably further includes a plasticizer which is selected from the group consisting of dialkyl adipate, dioctyl adipate, diisodecyl phthalate, diundecyl phthalate, alkyl benzyl phthalate, butyl benzyl phthalate, and combinations thereof.

The thermoplastic rubber in the primer composition preferably comprises a block copolymer such as a styrene-ethylene/propylene block copolymer.

The tackifier is preferably selected from the group consisting of hydrogenated polyalicyclic resins, aliphatic hydrocarbon resins, aromatic hydrocarbon resins, coumarone indene resin, esters of hydrogenated rosins, phenolic resins, and combinations thereof.

The volatile organic compound is preferably selected from the group consisting of aliphatic hydrocarbons, para-chlorobenzotrifluoride, aromatic hydrocarbons, ketone-based solvents, ester-based solvents, and blends thereof. Preferably, the volatile organic compounds comprises an aliphatic hydrocarbon and an aromatic hydrocarbon.

The primer composition may further include amounts of polyisobutylene and/or polybutene. These components function to improve the tack, bond strength and water resistance of the primer composition.

The primer composition preferably further includes an accelerator/cure package, which preferably comprises a mixture of a sulfur-containing composition and zinc oxide.

The primer composition also preferably further includes an antioxidant. The composition may also include minor amounts of coloring pigments, reinforcing agents, anti-settling agents, anti-freeze agents, and surfactants.

In a preferred embodiment of the invention, the primer composition comprises from about 1 to 5% by weight of a halogenated copolymer of isobutylene and p-methyl styrene, from about 1 to 5% by weight of a thermoplastic rubber, from about 1 to 10% by weight of a tackifier, and from about 65 to 90% by weight of the solvent comprising water and one or more volatile organic compounds. Preferably, the ratio of water to VOC compounds is from about 2:1 to about 5:1.

The composition preferably further includes from about 5 to 20% by weight of a plasticizer.

The present invention also provides a method of applying the primer composition to roofing materials. The method of priming roofing materials comprises applying the primer composition to a surface of a first roofing material to form a film; applying an adhesive to the primed surface of the first roofing material; and adhering a second roofing material to at least a portion of the primed and adhesive coated surface of the first roofing material. The roofing materials may comprise roofing or waterproofing membranes such as EPDM or TPO. The applied film of the primer composition has a thickness of about 1 to 3-mils. The use of the primer composition prior to the roofing adhesive results in a strong adhesive bond between the roofing materials.

Accordingly, it is a feature of the present invention to provide an effective primer composition for use on roofing materials which has a low VOC content. Other features and advantages of the invention will be apparent from the following detailed description and the appended claims.

### DETAILED DESCRIPTION OF THE PREFERRED EMBODIMENT

The primer composition of the present invention provides an improvement over currently available primer compositions in that the VOC content of the composition is less than 250 grams per liter (about 2.08 pounds per gallon). This is achieved by including water in the solvent as a partial replacement for the volatile organic compounds in the solvent. The resulting water/organic solvent blend has an increased dry rate, reduced freezing point, and provides better surface wetting. The primer composition also preferably includes a plasticizer, which contributes to the solids content of the composition and aids in reducing the VOC content.

The primer composition of the present invention preferably comprises a halogenated copolymer of isobutylene and p-methyl styrene, which provides low permeability properties as well as beneficial environmental and aging properties. Suitable halogenated copolymers are commercially available from ExxonMobil Chemical under the designations Exxpro 3035, Exxpro 3433 and Exxpro 3745. The halogenated copolymer comprises about 1 % to about 5% by weight of the composition.

A thermoplastic rubber comprising a block copolymer is also included in the primer composition to enhance the initial static load strength of the composition. Suitable block copolymers include styrene-butadiene-styrene, available from Kraton Polymers under the designations Kraton D1101, D1102, D1116, D1118, D1122, D1184, or D1300; or Calprene C401, C-411, C411X, C412, C416, C419, C484, C485, C-487, C-500, or C-501, commercially available from Dynasol Elastomers. Other suitable thermoplastic block copolymers include styrene-isoprene-styrene, such as Kraton D1107, D1111, D1112, D1113, D1117, D1119, D1124, D1125, D1193, or D1320, commercially available from Kraton Polymers, or KTR-801 or KTR-802, commercially available from Momentum Technologies. Another suitable block copolymer is styrene-ethylene/butadiene-styrene, such as Kraton G1650, G1651, G1652, G1654, G1657, G1726, G7723, or GRP6919, commercially available from Kraton Polymers; or Calprene H6110, 6120, 6140, or 6170, commercially available from Dynasol Elastomers. Styrene-ethyene/propylene block copolymers are also suitable and include Kraton G1701 or G1702, available from Kraton Polymers. Also suitable are ethylene/propylene block copolymers such as Kraton G1750 or G1765, commercially available from Kraton Polymers. The thermoplastic block copolymer is preferably included in an amount of from about 0.5 to about 5% by weight of the composition.

The primer composition also contains a tackifying resin. The tackifying resin may include hydrogenated polyalicyclic resins such as P-95, P-115, P-125, AND P-140, commercially available from Arakawa Chemical; Escorez 5380, 5300, 5320 or 5340, commercially available from ExxonMobil Chemical; Regalite R91, R101, R125, S260 or Regalrez 1018, 1085, 1094, 1126, 1128, 1139, 3102, 5095 or 6108, commercially available from Hercules; Eastotac H-100W, H-115W or H-130W, commercially available from Eastman Chemical; or Sukorez SU-100, SU-120, or SU-130, commercially available from Kolon Chemical.

Other suitable tackifying resins include aliphatic hydrocarbon resins including Escorez 1102, 1304, 1310LC, 1315 or 1504, commercially available from ExxonMobil Chemical; Nevtac 10, 80, 100 or 115, commercially available from Neville Chemical; Wingtack 10, 95 or Plus, commercially available from Goodyear Tire & Rubber; Eastotac H-100E, H-100R, H-100L, H-115E, H-115R, H-115L, H-130E, H-130R or H-130L, commercially available from Eastman Chemical; Adtac LV, Piccopale 100, Piccotac B, Piccotac 95 or Piccotac 115, commercially available from Hercules; Hikorez A-1100, A-1100S, C-1100, R-1100, R-1100S or T1080, commercially available from Kolon Chemical; or ADHM-100, commercially available from Polysat.

Suitable aromatic hydrocarbon tackifying resins include Nevchem 70, 100, 110, 120, 130, 140 or 150, commercially available from Neville Chemical; Escorez 7105 or 7312, commercially available from ExxonMobil Chemical; Hikotack P-90, P-90S, P-110S, P-120, P-120S, P-120HS, P-140, P-140M, P-150 or P-160, commercially available from Kolon Chemical; Picco 1104, 2100, 5120, 5130, 5140, 6085, 6100, 6115 or 9140; Piccodiene 2215 or Piccovar AP10, AP25 or L60, commercially available from Hercules.

Also suitable as tackifying resins are coumarone indene resins including Cumar P-10, P-25, R-1, R-3, R-5, R-6, R-7, R-9, R-10, R-11, R-12, R-13, R-14, R-15, R-16, R-17, R19, R-1, R-27, R-28, R-29, or LX-509, commercially available from Neville Chemical; Natrorez 10 or 25, commercially available from Natrochem.

Other suitable tackifying resins include esters of hydrogenated rosins including Foral 85 or 105; Pentalyn A or H; Hercolyn D, Stabelite Ester 10 or Albalyn, all commercially available from Hercules; Komotac KF-462S, commercially available from Momentum Technologies.

The tackifying resin may also comprise phenolic resins including Akron P-90 or P-133, commercially available from Akrochem; SP-1055, SP-1068 and SP-1077, commercially available from Schenectady Chemical; or Durez 31671, commercially available from Occidental Chemical; or Dyphene 8318 or 8320, commercially available from Sherwin Williams Company. It should be appreciated that the tackifying resin may comprise mixtures of all of the above resins. The tackifying resin(s) preferably comprise from about 1% to about 10% by weight of the composition.

The solvent used in the primer composition comprises water and at least one volatile organic compound. The water preferably comprises deionized water. The preferred volatile organic compounds for use in the present invention include parachlorobenzotriflouride, commercially available from Occidental Chemical under the designation Oxsol 100. Also suitable are aliphatic hydrocarbon solvents such as Lacolene (a blend of isomers of heptane) commercially available from Ashland Chemical; n-hexane, n-heptane, n-octane. Suitable aromatic hydrocarbons include toluene and xylene. It should be appreciated that blends of other aliphatic or aromatic organic solvents are also suitable for use in the present invention. In addition, oxygenated solvents, such as ethyl aetate, acetone, and other ketone and ester based solvents may be used up to about 25% of the total solvent amount so as to minimize swelling of roofing or waterproofing membranes. The aliphatic, aromatic, ester and ketone-based solvents are commercially available from a variety of suppliers including Ashland Chemical, Eastman Chemical, ExxonMobil Chemical and Shell Chemical. The solvent preferably comprises from about 50% to about 70% water and from about 15% to about 25% volatile organic compound(s), and preferably comprises from about 65% to 90% by weight of the composition, and more preferably, from about 70% to 85% by weight. Preferably, the ratio of water to VOC is from about 2:1 to about 5:1, and more preferably, from about 2:1 to about 3:1.

The primer composition also preferably contains a plasticizer. Suitable plasticizers include dialkyl adipate, dioctyl adipate, diisodecyl phthalate, diundecyl phthalate, alkyl benzyl phthalate or butyl benzyl phthalate, commercially available from Ashland Chemical, Eastman Chemical or Solutia. The plasticizer preferably comprises from about 5 to about 20% by weight of the composition.

The primer composition also preferably contains polyisobutylene, which may comprise a high molecular weight polyisobutylene such as Vistanex L-80, L-100, L-120, or L-140, commercially available from ExxonMobil Chemical Company, or Oppanol B-30, B-50, B-80, B-100, B-150 or B-200, commercially available from BASF Corporation. Suitable low molecular weight polyisobutylenes include CP-24, LM-MS, LM-MH, LM-H or LM-S, commercially available from ExxonMobil Chemical; Oppanol B-10, B-12, B-13 or B-15, commercially available from BASF Corporation; P-12 or P-15, commercially available from Alcan Rubber and Chemical; or 4.0H, 4.5H, 5.0H, 5.5H, or 6HT, commercially available from RitChem. Mixtures of these polyisobutylene components may also be used. The polyisobutylene is preferably included in the composition in amounts of from about 0.3 to 3% by weight.

The primer composition may also include a polybutene, for example, Parapol 450, 700, 950, 1300, 2200 or 2500, commercially available from ExxonMobil Chemical; or Indopol L-2, L-3, L-6, L-8, L-14, L-50, H-7, H-8, H-15, H-25, H-35, H-50, H-100, H-300, H-1500, H-1900, H-2100, H-6000 or H18000, commercially available from BPAmoco Chemical. The polybutene may be included in amounts of about 0.3 to 3% by weight.

The primer composition also includes an accelerator/cure package or system. The present composition may be cured using several well-known curing systems including sulfur and sulfur-containing systems as well as zinc oxide. Typically, about 0.5 to about 2% by weight of the accelerator/cure package in the composition is sufficient. Preferably, the accelerator/cure package comprises a mixture of sulfur, benzothiazyl disulfide (MBTS), magnesium oxide, and zinc oxide. Other suitable accelerators for use in the accelerator/cure package include thiazoles and dithiocarbamates. By way of example, the following materials may also be used in the accelerator/cure package: 4,4′ dithiodimorpholine, 2-(morpholoino-dithio)-benzothiazole; zinc mercaptobenzothiazole; zinc dibutyl dithiocarbamate; zinc diethyl dithiocarbamate; zinc dimethyl dithiocarbamate; copper dibenzyl dithiocarbamate; tellurium diethyl dithiocarbamate; and mixtures thereof, all commercially available from Akrochem, R.T. Vanderbilt, Akzo, Dupont, Monsanto Chemical, Pennwalt or Uniroyal Chemical.

The primer composition also preferably includes an antioxidant. Suitable antioxidants include Irganox 1010, 1076 or 1520, commercially available from Ciba-Geigy; or Wingstay C, K, L, S, or T, commercially available from Goodyear Tire & Rubber.

The primer composition may also include minor portions of coloring pigments, for example, titanium dioxide, to make the product white or light in color, or carbon black or coal filler to make the product black or dark in color.

The primer composition also preferably contains a reinforcing agent. Suitable reinforcing agents include hydrophilic fumed silica, such as Aerosil 90, 130, 150, 200, 300 or 380, commercially available from Degussa; or Cab-O-Sil H-5, HS-5, L-90, LM-130, LM-150, M-5, PTG, MS-55 or EH-5, commercially available from Cabot. Also suitable are hydrophobic fumed silicas, such as Aerosil R202, R805, R812, R812S, R972, R974 or US202, commercially available from Degussa; or Cab-O-Sil TS-530, TS-610 or TS-720, commercially available from Cabot. Also suitable is hydrated amorphous precipitated silica, including Hi-Sil 132, 135, 210, 233, 243LD, 255, 532EP, 752, 900, 915 or 2000, commercially available from PPG Industries; or Hubersil 162, 162LR, 1613, 1633, 1714, 1743, or 4151 H, commercially available from J.M. Huber, or Garamite 1958, commercially available from Southern Clay Products.

The primer composition may also contain an organoclay anti-settling agent, for example, Bentone 27, 34, 38, 52, 57, 120, 128, 760, 910, 1000, SD-1, SD-2, or SD-3, commercially available from Elementis Specialties; Claytone II, 34, 38H, 40, 50, 409, 738, 2000, AF, APA, ED, GF, GR, HT, HY, LG, S, TP, TPSA or XL, commercially available from Southern Clay Products. Additional anti-settling agents may include Tixogel EPA, EZ-100, EZ-200, GM, KM, LG, MP, MP-100, MP-250, MP-300, MPG, TE, TP, TP-100, UN, VG-69, VP, VPA, VPLS or VZ, commercially available from Sud Chemie; or Organotrol 3440, SA, SA-7 or SA-2000, commercially available from Cimbar Performance Minerals.

The primer composition may also contain an anti-freeze agent, such as diethylene glycol, dipropylene glycol, ethylene glycol, hexylene glycol, propylene glycol, triethylene glycol or tripropylene glycol, all of which are commercially available from Ashland Chemical, Eastman Chemical or ExxonMobile Chemical.

The primer composition also preferably contains a non-ionic surfactant such as alkylphenoxypolyoxyethylene ethanol. Suitable surfactants include Makon 4, 10, 12, or 14, commercially available from Stepan.

The primer composition of the present invention is preferably prepared by first mixing the halogenated copolymer of isobutylene and p-methyl styrene, polyisobutylene or polybutene, antioxidant, anti-settling agent, and accelerator/cure package in a volatile organic compound, preferably an aromatic solvent, together in a double arm sigma blade mixer. The mixture is preferably stirred for about 8 hours until the dry components are uniformly dispersed in the solvent. The thermoplastic block copolymer, tackifier, reinforcing agent, anti-freeze agent, and a volatile organic compound, preferably an aliphatic solvent, are added to the mixture until uniformly dispersed. To this mixture, a surfactant, plasticizer, and deionized water are added until uniformly dispersed to ensure good dispersion of all components.

The resulting primer composition may be used to prime sheets of a roofing or waterproofing membrane. The primer composition is preferably applied in a thin film to the surface of a roofing or waterproofing membrane such as EPDM or TPO. The primer composition may be applied with a cloth rag, a foam -brush, paint brush, roller, or an abrasive cleaning pad. The use of an abrasive applicator is preferred as it has been found to loosen surface dust and deliver an even coat of the primer composition. The primer wets out the surface of the membrane and is readily absorbed into the membrane surface. After the primer composition has dried, it remains partially tacky. A roofing adhesive material such as a liquid adhesive, roofing tape, or pre-applied hot melt pressure sensitive adhesive is then placed on the primed surface of the roofing or waterproofing membrane and a second roofing or waterproofing membrane is overlapped in a conventional manner to form a lap joint. Pressure is applied to firmly bond the two sheets together. The resultant bond exhibits high bond strength and is resistant to degradation by environmental conditions such as thermal fluctuations. After the two sheets are joined, a cut edge sealant for TPO or a lap sealant caulking material for EPDM or TPO may be used at the edge of the joint to provide additional protection against water infiltration.

In order that the invention may be more readily understood, reference is made to the following examples which are intended to illustrate the invention, but not limit the scope thereof.

### EXAMPLE 1

Three sets of primer compositions were prepared in accordance with the present invention. The proportions of each component in the compositions designated as 1A, 1B, 1C and 2A, 2B and 2C are listed in Tables 1 and 2 as parts by weight.

The Premix formulation included in the compositions is as follows:

Premix

| Component | % by weight |
|---|---|
| Halogenated copolymer of isobutylene | 25.60 |
| and p-methyl styrene¹ | |
| Antioxidant² | 0.78 |
| Anti-settling agent³ | 3.90 |
| Polyisobutylene⁴ | 7.81 |
| Accelerator/cure package⁵ | 1.02 |
| Toluene | 60.89 |

¹Exxpro 3433 from ExxonMobil
²Wingstay L from Goodyear Tire & Rubber
³Organotrol 3440
⁴CP-24
⁵RM-0546

TABLE 1

| | 1A | 1B | 1C |
|---|---|---|---|
| Pre-Mix | 16.0 | 16.0 | 16.0 |
| Styrene-ethylene/butadiene-styrene¹ | 6.0 | 6.0 | 6.0 |
| Tackifier(s) | 13.8 | 13.8 | 13.8 |
| Reinforcing agent | 12.0 | 9.0 | 6.0 |
| Polybutene² | 2.5 | 2.5 | 2.5 |
| Ethylene glycol | 1.2 | 0.9 | 0.6 |
| Aliphatic hydrocarbon solvent³ | 100.0 | 100.0 | 100.0 |
| Para-benzotrifluoride | 50.0 | 50.0 | 50.0 |
| Dioctyl adipate | 73.0 | 73.0 | 73.0 |
| Surfactant | 18.0 | 18.0 | 18.0 |
| Water | 400.0 | 400.0 | 400.0 |

¹Kraton G-1650 from Kraton Polymers
²H-1900 from BP Amoco Chemical
³Lacolene from Ashland Chemical

TABLE 2

| | 2A | 2B | 2C |
|---|---|---|---|
| Pre-Mix | 41.0 | 41.0 | 41.0 |
| Styrene-ethylene/butadiene-styrene¹ | 6.0 | 6.0 | 6.0 |
| Tackifier(s) | 13.8 | 13.8 | 13.8 |
| Reinforcing agent | 16.0 | 16.0 | 18.0 |
| Ethylene glycol | 0.2 | 0.2 | 0.2 |
| Heptane | 180.0 | 180.0 | 180.0 |
| Dioctyl adipate | 73.0 | 73.0 | 73.0 |
| Surfactant | 18.0 | 20.0 | 19.0 |
| Water | 450.0 | 500.0 | 475.0 |

¹Kraton G-1650 from Kraton Polymers

All of the above compositions were tested to determine solids content, VOC content, specific gravity, weight per gallon, viscosity, dead load shear at 70° C., peel strength at room temperature and at 70° C. The peel strengths were measured after application of the primer compositions to two separate sheets of EPDM rubber membrane; a black rubber adhesive tape (ADCO SP-505) was applied to the first primed sheet; the second primed sheet was applied on top of the tape to form a seam. The results are shown in Table 3. Solids content was determined by ASTM standard test method C 681. VOC content was determined by ASTM Standard test method D 3960. The weight per gallon and specific gravity were determined by ASTM standard test method D 1475.

TABLE 3

| | 1A | 1B | 1C | 2A | 2B | 2C |
|---|---|---|---|---|---|---|
| Solids content (%) | 20.6 | 20.2 | 19.8 | 18.1 | 17.2 | 17.8 |
| VOC Content (gm/L) | 153 | 154 | 155 | 236 | 223 | 230 |
| Specific Gravity | 0.97 | 0.97 | 0.97 | 0.92 | 0.93 | 0.92 |
| Weight per gallon (lbs) | 8.08 | 8.08 | 8.08 | 7.66 | 7.66 | 7.66 |
| Brookfield viscosity | 3900 | 3600 | 2400 | 4000 | 3000 | 3500 |
| (cps) | | | | | | |
| Dead Load Shear @ | Failed | Passed | Failed | Passed | Passed | Passed |
| 70° C. | | | | | | |
| Peel Strength, 24 hrs | 5.6 | 4.7 | 4.7 | 4.7 | 6.9 | 5.9 |
| @ RT, RT (pli) | | | | | | |
| Peel Strength, 24 hrs | 8.7 | 5.7 | 6.1 | 5.5 | 9.8 | 9.9 |
| @70° C., RT (pli) | | | | | | |
| Peel Strength, 24 hrs | 2.4 | 2.5 | 1.9 | 3.7 | 4.0 | 4.1 |
| @70° C., 70° C. (pli) | | | | | | |
| Shear Strength, 24 hrs | 18.3 | 17.2 | 16.7 | 21.1 | 22.8 | 22.6 |
| @ RT, RT (psi) | | | | | | |
| Shear Strength, 24 hrs | 18.2 | 19.9 | 21.0 | 26.2 | 34.1 | 33.9 |
| @ 70° C., RT (psi) | | | | | | |
| Shear Strength, 24 hrs | 11.2 | 10.4 | 13.7 | 17.9 | 21.3 | 21.2 |
| @70° C., 70° C. (psi) | | | | | | |

With regard to dead load shear, by “failed”, it is meant that there was greater than 0.125 inches of movement or “slippage”. In order to pass, no more than 0.125 inches of separation of the seam must occur within 24 hours of exposure at 70° C.

### EXAMPLE 2

Compositions 2B and 2C from Example 1 were tested on TPO roofing membranes by applying the primer compositions to two separate TPO membranes. A white rubber adhesive tape (ADCO SP-605) was applied to the first primed sheet and the second primed sheet was applied on top of the tape to form a seam. The results are shown below in Table 4.

TABLE 4

| | 2B | 2C |
|---|---|---|
| Dead Load Shear @ 55° C. | Passed | Passed |
| Peel Strength, 24 hrs @ RT, RT (pli) | 9.5 | 7.4 |
| Peel Strength, 24 hrs @55° C., RT (pli) | 16.7 | 15.8 |
| Peel Strength, 24 hrs @55° C., 55° C. (pli) | 2.6 | 2.8 |
| Shear Strength, 24 hrs @ RT, RT (psi) | 38.9 | 39.7 |
| Shear Strength, 24 hrs @ 55° C., RT (psi) | 34.1 | 51.5 |
| Shear Strength, 24 hrs @55° C., 55° C. (psi) | 22.6 | 23.1 |

While certain representative embodiments and details have been shown for purposes of illustrating the invention, it will be apparent to those skilled in the art that various changes in the methods and apparatus disclosed herein may be made without departing from the scope of the invention, which is defined in the appended claims.

1. A primer composition for use on roofing materials comprising:
a halogenated copolymer of isobutylene and p-methyl styrene;
a thermoplastic rubber;
a tackifier;
a solvent comprising water and at least one volatile organic compound, said composition having a volatile organic compound (VOC) content of less than about 250 g/l.

2. The primer composition of claim 1 further including a plasticizer.

3. The primer composition of claim 2 wherein said plasticizer is selected from the group consisting of dialkyl adipate, dioctyl adipate, diisodecyl phthalate, diundecyl phthalate, alkyl benzyl phthalate, butyl benzyl phthalate, and combinations thereof.

4. The primer composition of claim 1 wherein said thermoplastic rubber comprises a styrene-ethylene/propylene block copolymer.

5. The primer composition of claim 1 wherein said tackifier is selected from the group consisting of hydrogenated polyalicyclic resins, aliphatic hydrocarbon resins, aromatic hydrocarbon resins, coumarone indene resin, esters of hydrogenated rosins, phenolic resins, and combinations thereof.

6. The primer composition of claim 1 wherein said volatile organic compound is selected from the group consisting of aliphatic hydrocarbons, parachlorobenzotrifluoride, aromatic hydrocarbons, ketone-based solvents, ester-based solvents, and blends thereof.

7. The primer composition of claim 6 wherein said volatile organic compound comprises an aliphatic hydrocarbon and an aromatic hydrocarbon.

8. The primer composition of claim 1 further including an accelerator/cure package.

9. The primer composition of claim 1 further including an antioxidant.

10. The primer composition of claim 1 further including polyisobutylene.

11. The primer composition of claim 1 further including polybutene.

12. A primer composition for use on roofing materials comprising:
from about 1 to 5% by weight of a halogenated copolymer of isobutylene and p-methyl styrene;
from about 0.5 to 5% by weight of a thermoplastic rubber;
from about 1 to 10% by weight of a tackifier;
from about 65 to 90% by weight of a solvent comprising water and at least one volatile organic compound, said composition having a volatile organic compound (VOC) content of less than about 250 g/l.

13. The primer composition of claim 12 wherein the ratio of water to said volatile organic compound is from about 2:1 to about 5:1.

14. The primer composition of claim 12 further including from about 5 to 20% by weight of a plasticizer.

15. The primer composition of claim 14 wherein said plasticizer is selected from the group consisting of dialkyl adipate, dioctyl adipate, diisodecyl phthalate, diundecyl phthalate, alkyl benzyl phthalate, butyl benzyl phthalate, and combinations thereof.

16. The primer composition of claim 12 wherein said thermoplastic rubber comprises a styrene-ethylene/propylene block copolymer.

17. The primer composition of claim 12 wherein said tackifier is selected from the group consisting of hydrogenated polyalicyclic resins, aliphatic hydrocarbon resins, aromatic hydrocarbon resins, coumarone indene resin, esters of hydrogenated rosins, phenolic resins, and combinations thereof.

18. The primer composition of claim 12 wherein said volatile organic compound is selected from the group consisting of aliphatic hydrocarbons, parachlorobenzotrifluoride, aromatic hydrocarbons, ketone-based solvents, ester-based solvents, and blends thereof.

19. The primer composition of claim 12 further including an accelerator/cure package.

20. The primer composition of claim 12 further including polyisobutylene.

21. The primer composition of claim 12 further including polybutene.

22. A method of priming roofing materials comprising:
a) providing a primer composition comprising a halogenated copolymer of isobutylene and p-methyl styrene, a thermoplastic rubber, a tackifier, and a solvent comprising water and at least one volatile organic compound;
b) applying said primer composition to a surface of a first roofing material to form a film;
c) applying an adhesive to the primed surface of said first roofing material; and
d) adhering a second roofing material to at least a portion of said primed and adhesive coated surface of said first roofing material.

23. The method of claim 22 wherein said roofing materials comprise roofing or waterproofing membranes.

24. The method of claim 22 wherein said membranes are comprised of EPDM or TPO.

25. The method of claim 22 wherein said applied film of said primer composition has a thickness of about 1 to 3 mils.
